(19) United States
(12) Patent Application Publication
(10) Pub. No.: US 2020/0355284 A1
(43) Pub. Date: Nov. 12, 2020

(54) Valve Assembly

(71) Applicant: Gary W. Spangler, Wilmington, NC (US)

(72) Inventor: Gary W. Spangler, Wilmington, NC (US)

(21) Appl. No.: 16/409,861

(22) Filed: May 12, 2019

(51) Int. Cl. F16K 15/02

(52) U.S. Cl. CPC F16K 15/026

(57) ABSTRACT

A valve assembly includes a valve having a disc with a cross sectional area that has been reduced. Moreover, a curvature of a face of the disc has been made convex to eliminate stagnation in front of the disc. An outer edge of the disc and guide may include a contoured profile based on the design of an air foil.

### I. FIELD OF THE DISCLOSURE

The disclosure relates to valve systems, and more particularly, to wafer check valves.

### II. BACKGROUND

Flow capacity in check valves can be compromised by the internal valve hardware used to selectively regulate flow. The flow must circumvent the hardware, which can slow the flow rate and hinder valve performance.

### III. SUMMARY OF THE DISCLOSURE

According to a particular embodiment, an apparatus includes a valve assembly structure, including an inlet and an outlet, as well as a disc structure having a convex surface facing the inlet.

The face of a disc guide is forward relative to the inlet disc structure and is positioned forward of a halfway point of a flow area relative to the inlet. According to an embodiment, the apparatus includes an axial wafer check valve. The fluid may flow in a laminar flow proximate a portion of the convex surface and in a turbulent flow downstream from the convex surface. The flow may have a Reynolds Number of less than 2100. The turbulent flow may have a Reynolds Number of more than 4000. The convex surface may transition a flow of the fluid from laminar to turbulent.

According to a particular embodiment, the disc structure includes a disc guide, and the disc guide includes a concave surface. According to another embodiment, the disc guide includes a convex surface. Fins of the valve assembly may be configured to support a disc guide.

These and other advantages and features that characterize embodiments are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments.

### IV. BRIEF DESCRIPTION OF THE DRAWINGS

FIG. 1 is a cross sectional view of a valve assembly according to a particular embodiment;

FIG. 2 is a cross sectional view of an embodiment of a valve assembly that includes a disc positioned in an open position to allow flow; and

FIG. 3 is a flowchart showing steps for manufacturing a check valve assembly that is consistent with an embodiment of the invention.

### V. DETAILED DESCRIPTION

A valve assembly includes a valve having a disc with a cross sectional area that has been reduced. Moreover, a curvature of a face of the disc has been made convex to eliminate stagnation in front of the disc. An outer edge of the disc and guide may include a contoured profile based on the design of an air foil.

In a particular embodiment, an apparatus includes a valve assembly having a disc with a relatively small cross sectional area. Moreover, a curvature of a face of the disc may be contoured all around. Discs are conventionally flat on the front surface. An outer edge of the disc and guide of an embodiment of the invention may include a contoured profile based on the design of an air foil. This design eliminates the flow stagnation behind the disc by leaving no gaps that the flow must fill in. Additionally, the optimized slope of the guide may support the flow, reducing the high speeds it must reach in order to make it around the disc and guide assembly. The body wall of the disc has been brought in to mimic the contours of the flow path, eliminating stagnation zones and eliminating wasted space. This feature allows the disc and guide to be brought forward, making the down flow slope of the guide much gentler and energy efficient.

The concave/convex design on the front end of the disc reduces the velocity of the fluid flowing through the valve to achieve lower pressure loss. An embodiment maximizes the area inside of the valve on the backside to reduce velocity by using a convex design. The convex design may reduce stagnation. Lower velocity may otherwise lead to high pressure and pressure loss.

An embodiment may shift internal hardware (e.g., the disc guide) forward towards the face of the valve to transition the fluid flow from laminar flow to turbulent flow. By increasing fluid velocity on front end, the system may modify the flow from laminar to turbulent flow. By restricting the flow area by moving the disc forward, the system increases the velocity and initiates a turbulent flow. The turbulent flow has a boundary flow that will stay attached to a boundary surface for a greater distance. By using convex geometry (rather than concave or flat geometry), the turbulent flow is preserved along the boundary of the convex disc surface. This feature may result in a smaller wake area and low pressure zone.

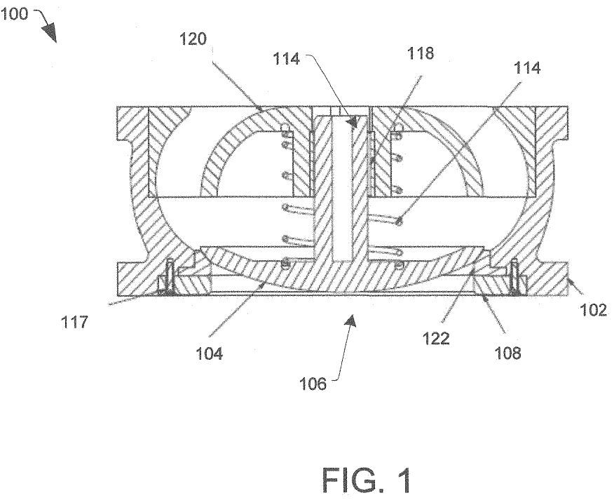

FIG. 1 shows a cross sectional view of a valve assembly 100 consistent with an embodiment of the invention. According to a particular embodiment, the valve assembly 100 may comprise an axial wafer check valve, as having specifications described in American Petroleum Institute (API) Standards, (i.e., API 1594). The valve assembly 100 includes a valve body 102 and a disc 104. The disc 104 may be convex with respect to a valve inlet 106. As discussed herein, the curvature of the disc 104 affects flow throughout the valve assembly 100. The valve assembly 100 further includes a retainer 108 to provide structural support, and a shaft 114 to axially move the disc 104 to an open, closed, intermediate position. As shown in FIG. 1, the disc 104 and valve assembly 100 are in a closed position, restricting flow. A spring 116, screw 117, and bushing 118 are also shown in FIG. 1, along with a disc guide 120, 122. The surface of the disc guide 120 is convex in FIG. 1. The convex design may affect (e.g., increase) fluid velocity to decrease fluid pressure.

This design may have particular application in a wafer check valve, which has smaller dimensions (i.e., less area) in which to decrease internal valve pressure. When opened, fluid flow may transition from laminar around the disc 104 to turbulent around the guide 120. The transition from laminar to turbulent flow is facilitated by the disc 104 being positioned relatively closer to the inlet than in conventional valve assemblies. The boundary layer of a turbulent flow may remain closer to the surface of the guide 120, resulting in lower pressure. The design may further reduce pockets of stagnation around the back end of the disc 104 and guide 120.

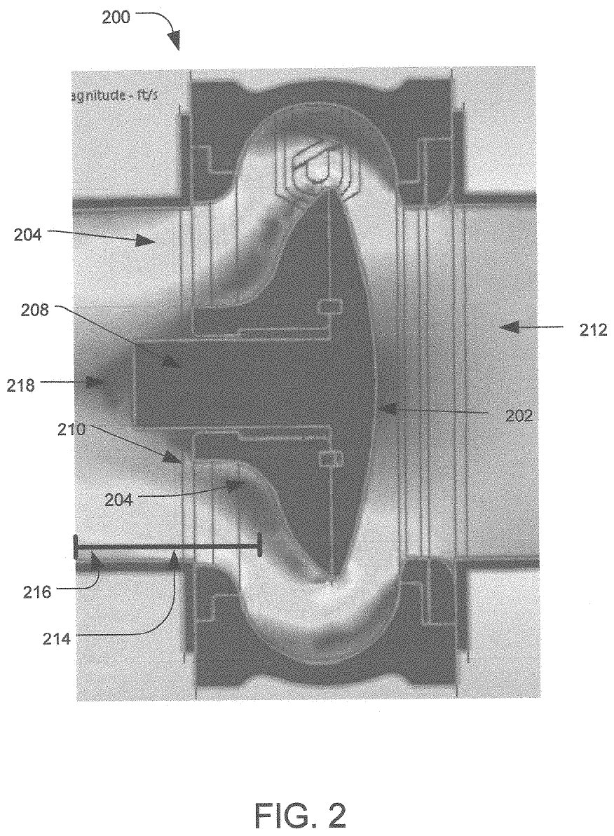

FIG. 2 shows a cross sectional view of a valve assembly 200 consistent with another embodiment of the invention. More particularly, FIG. 2 shows an embodiment of a valve assembly 200 that includes a contoured disc 202 positioned in an open position to allow fluid flow throughout the valve assembly 200. In contrast to the valve assembly 100 of FIG. 1, the valve assembly of FIG. 2 has a concave disc guide 204. Lines 206 delineate flow around the disc 202 and through the valve assembly 200. The valve assembly 200 may include a shaft 208 to traverse the disc 202 and fins 210 to provide structural support.

An outer edge of the disc 202 and guide 204 may include a contoured profile based on the design of an air foil. As with the assembly design of FIG. 2, this design may reduce flow stagnation behind the disc 202 by limiting gaps that the flow must fill in. Additionally, the optimized slope of the guide 204 supports the flow, reducing the high speeds it must reach in order to make it around the disc 202 and guide 204. The body wall of the disc has been brought in to mimic the contours of the flow path, reducing stagnation zones and wasted space. This feature allows the disc and guide to be brought forward, making the down flow slope of the guide much gentler and energy efficient.

The forward position of the disc 202 allows the flow to change from laminar as the fluid flows over the disc 202 to turbulent as the fluid leaves the disc towards the guide 204. A Reynolds number is one way of characterizing flow rates. The Reynolds number is a measure of the ratio of the inertia force on an element of fluid to the viscous force of an element. If the Reynolds number is low (less than 1), it is an indication that the viscous forces are dominant. At Reynold's numbers above 10⁵, the fluid can be considered to be non-viscous, and the flow transitions to turbulent flow. In another example, laminar flow may be less than 2100, and turbulent may be greater than 4000. Transitional Flow may prevail between these two illustrative ranges.

By moving the guide closer to the entrance of the valve the flow area is decreased, and the velocity increases. The Reynolds Number increases with the fluid velocity, causing the fluid to transition to turbulent flow. If the guide to flow area ratio is above 50%, it indicates that the flow area is restricted by the guide's offset.

TABLE 1
Sample NZW Valve Geometry Analysis

| | VALVE FACE | INLET | GUIDE | GUIDE TO |
|---|---|---|---|---|
| VALVE | TO FACE | DISTANCE | HEIGHT | FLOW AREA |
| NFS SIZE | [IN] | [IN] | [IN] | RATIO |
| 2″ | 2.38 | 0.71 | 1.10 | 66% |
| 2½″ | 2.62 | 0.78 | 1.25 | 68% |
| 3″ | 2.88 | 0.88 | 1.38 | 69% |
| 4″ | 2.88 | 0.68 | 1.38 | 63% |

By way of another way of explaining the forward position of the disc 202, the disc 202 may be positioned forward (i.e., towards the inlet 212) of a position 214 that is more than halfway along a flow path channel 216. The flow path channel 216 may include a relatively straight section of the valve assembly ranging from behind the guide 204, or disc 202, or face of the guide 204, to an outlet 218 of the valve assembly 200. Moving the disc 202 forward may raise the velocity by restricting the flow area, thus causing the transition to turbulent flow.

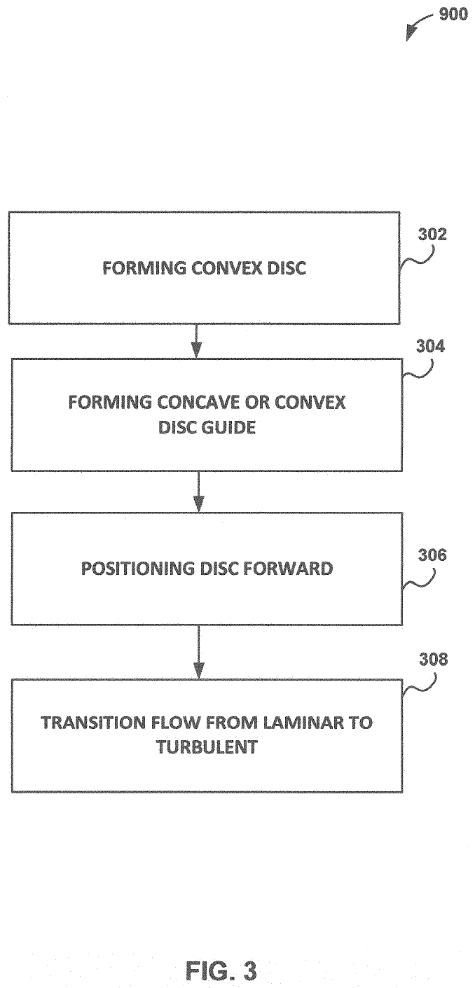

FIG. 3 is a flowchart having steps consistent with manufacturing a valve assembly in accordance with an embodiment of the invention. At block 902, a convex or otherwise contoured disc may be formed. A disc guide of one embodiment may be convex, while the disc guide of another embodiment may be concave at 904. The disc may be positioned in a forward are of the valve assembly at 906. The configuration may cause the fluid flow to transition at 908 from laminar flow to turbulent flow to achieve a desired pressure.

Those skilled in the art may make numerous uses and modifications of and departures from the specific apparatus and techniques disclosed herein without departing from the inventive concepts. Consequently, the disclosed embodiments should be construed as embracing each and every novel feature and novel combination of features present in or possessed by the apparatus and techniques disclosed herein and limited only by the scope of the appended claims, and equivalents thereof.

1. An apparatus comprising:
a valve assembly structure, including an inlet and an outlet; and
a disc structure having a convex surface facing the inlet.

2. The apparatus of claim 1, wherein a face of a disc guide is forward relative to the inlet and the disc structure is positioned forward of a halfway point of a flow area relative to the inlet.

3. The apparatus of claim 1, wherein the apparatus includes an axial wafer check valve.

4. The apparatus of claim 1, wherein the fluid flows in a laminar flow proximate a portion of the convex surface and in a turbulent flow downstream from the convex surface.

5. The apparatus of claim 4, wherein the laminar flow has a Reynolds Number of less than 2100.

6. The apparatus of claim 4, wherein the turbulent flow has a Reynolds Number of more than 4000.

7. The apparatus of claim 1, wherein the convex surface transitions a flow of the fluid from laminar to turbulent.

8. The apparatus of claim 1, wherein disc structure includes a disc guide, and wherein the disc guide includes a concave surface.

9. The apparatus of claim 1, wherein disc structure includes a disc guide, and wherein the disc guide includes a convex surface.

10. The valve assembly of claim 1, further comprising fins configured to support a disc guide.

11. A method of manufacturing a check valve, the method comprising:
providing a valve assembly structure that includes an inlet and an outlet; and
providing a disc structure having a convex surface facing the inlet.

12. The method of claim 11, positioning a face of a disc guide forward relative to the inlet, and positioning the disc structure forward of a halfway point of a flow area relative to the inlet.

13. The method of claim 11, wherein the apparatus includes an axial wafer check valve.

14. The method of claim 11, wherein the fluid flows in a laminar flow proximate a portion of the convex surface and in a turbulent flow downstream from the convex surface.

15. The method of claim 14, wherein the laminar flow has Reynolds Number of less than 2100.

16. The method of claim 14, wherein the turbulent flow has Reynolds Number of more than 4000.

17. The method of claim 11, wherein the convex surface transitions a flow of the fluid from laminar to turbulent.

18. The method of claim 11, wherein disc structure includes a disc guide, and wherein the disc guide includes a concave surface.

19. The method of claim 11, wherein disc structure includes a disc guide, and wherein the disc guide includes a convex surface.

20. The method of claim 11, further comprising providing fins to support a disc guide.
